(19) United States
(12) Patent Application Publication
(10) Pub. No.: US 2026/0330352 A1
(43) Pub. Date: Oct. 22, 2026

(54) INFORMATION PROCESSING APPARATUS, PROJECT PROCESSING SUPPORT METHOD, AND NON-TRANSITORY COMPUTER READABLE MEDIUM

(71) Applicant: NEC Corporation, Tokyo (JP)

(72) Inventors: Hisaya WAKAYAMA, Tokyo (JP); Shin NORIEDA, Tokyo (JP); Kenichi TAKIGUCHI, Tokyo (JP); Chisho UEDA, Tokyo (JP); Yuto TSUKADA, Tokyo (JP)

(73) Assignee: NEC Corporation, Tokyo (JP)

(21) Appl. No.: 19/468,032

(22) Filed: Feb. 3, 2026

(30) Foreign Application Priority Data
Mar. 14, 2025 (JP) 2025-041814

(51) Int. Cl. G06Q 10/0631; G06F 40/40

(52) U.S. Cl. CPC G06Q 10/063118; G06Q 10/06313; G06F 40/40

(57) ABSTRACT

Provided is a technique for supporting a project so that the project can be appropriately processed. An information processing apparatus includes an analysis unit that estimates a matter to be supplemented in processing of a subject project by personnel based on requirement characteristics required in processing of the project and characteristics of one or a plurality of personnel allocated to the project, and an allocation determination unit that determines a resource to be allocated to the project in addition to the personnel based on a result of the estimating. According to the information processing apparatus, it is also possible to optimize personnel and resources to be allocated to a project. The proposed information processing apparatus facilitates efficient decision making by utilizing advanced AI-driven resource allocation.

This application is based upon and claims the benefit of priority from Japanese patent application No. 2025-041814, filed on Mar. 14, 2025, the disclosure of which is incorporated herein in its entirety by reference.

### TECHNICAL FIELD

The present disclosure relates to an information processing apparatus, a project processing support method, and a project processing support program.

### BACKGROUND ART

In various organizations such as companies, personnel is allocated to each project to be processed, and the allocated personnel is caused to process the project. In the project processing according to such an aspect, it is important to allocate an appropriate personnel according to the project, and there is also a technology for achieving appropriate allocation. For example, the following JP 2007-122144 A discloses a system that selects a member of a project team so as to achieve an ability characteristic value as a team that enhances evaluation for the project.

### SUMMARY

The system described in JP 2007-122144 A is considered to be effective in an organization having abundant human resources to achieve the ability characteristic value as a team. However, in many companies, it is necessary to process projects with limited personnel, and it is not easy to appropriately process projects with limited personnel.

The present disclosure has been made in view of the above problems, and an example object of the present disclosure is to provide a technique for supporting a project so that the project can be appropriately processed even if the number of personnel that can be allocated to the project is limited.

An information processing apparatus according to an example aspect of the present disclosure includes an analysis means for estimating a matter to be supplemented in processing of a subject project by personnel based on requirement characteristics required in processing of the project and characteristics of one or a plurality of personnel allocated to the project, and an allocation determination means for determining a resource to be allocated to the project in addition to the personnel based on a result of the estimating.

In a project processing support method according to an example aspect of the present disclosure, at least one processor executes analysis processing of estimating a matter to be supplemented in processing of a subject project by personnel based on requirement characteristics required in processing of the project and characteristics of one or a plurality of personnel allocated to the project, and allocation determination processing of determining a resource to be allocated to the project in addition to the personnel based on a result of the estimating.

A project processing support program according to an example aspect of the present disclosure causes a computer to function as an analysis means for estimating a matter to be supplemented in processing of a subject project by personnel based on requirement characteristics required in processing of the project and characteristics of one or a plurality of personnel allocated to the project, and an allocation determination means for determining a resource to be allocated to the project in addition to the personnel based on a result of the estimating.

According to an exemplary aspect of the present disclosure, there is an exemplary effect that it is possible to provide a technology for supporting a project so that the project can be appropriately processed even if the number of personnel that can be allocated to the project is limited.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating a configuration of an information processing apparatus according to the present disclosure;

FIG. 2 is a flowchart illustrating a flow of a project processing support method according to the present disclosure;

FIG. 3 is a block diagram illustrating a configuration of another information processing apparatus according to the present disclosure;

FIG. 4 is a diagram illustrating an estimation example of a subject matter;

FIG. 5 is a flowchart illustrating an example of processing executed by the information processing apparatus illustrated in FIG. 3;

FIG. 6 is a flowchart illustrating an example of processing executed by a generation control unit;

FIG. 7 is a flowchart illustrating an example of processing of automatically generating a team including personnel and an agent; and

FIG. 8 is a block diagram illustrating a configuration of a computer that functions as an information processing apparatus according to the present disclosure.

### EXAMPLE EMBODIMENTS

Hereinafter, example embodiments of the present disclosure will be exemplified. However, the present disclosure is not limited to the following illustrative example embodiments, and various modifications may be made within the scope described in the claims. For example, the following example embodiments obtained by appropriately combining techniques (some or all of objects or methods) adopted in the illustrative example embodiments may also fall within the scope of the present disclosure. Example embodiments obtained by appropriately omitting some of the techniques adopted in the following illustrative example embodiments may also fall within the scope of the present disclosure. Effects mentioned in the following illustrative example embodiments are examples of effects expected in the illustrative example embodiments, and do not define extension of the present disclosure. That is, example embodiments that do not exert the effects mentioned in the following illustrative example embodiments may also fall within the scope of the present disclosure.

### First Illustrative Example Embodiment

A first illustrative example embodiment, which is an example of the example embodiments of the present disclosure, will be described in detail with reference to the drawings. The present illustrative example embodiment is a basic form of each of the illustrative example embodiments described later. An application range of each technique adopted in the present illustrative example embodiment is not limited to the present illustrative example embodiment. That is, each technique adopted in the present illustrative example embodiment can also be adopted in another illustrative example embodiment included in the present disclosure within a range in which no particular technical problem occurs. Furthermore, each technique illustrated in the drawings referred to for describing the present illustrative example embodiment can also be adopted in another illustrative example embodiment included in the present disclosure within a range in which no particular technical problem occurs.

### Configuration of Information Processing Apparatus 1

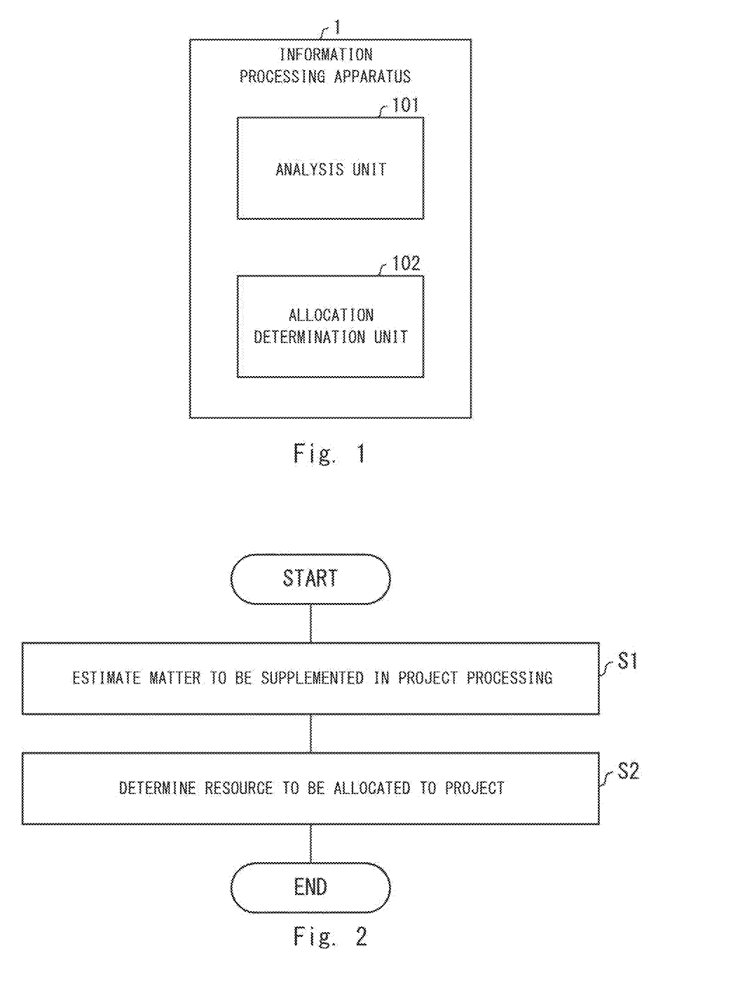

A configuration of an information processing apparatus 1 according to the present illustrative example embodiment will be described with reference to FIG. 1. FIG. 1 is a block diagram illustrating the configuration of the information processing apparatus 1. As illustrated in FIG. 1, the information processing apparatus 1 includes an analysis unit 101 and an allocation determination unit 102.

The analysis unit 101 estimates a matter to be supplemented in the processing of the project by the personnel based on the requirement characteristics required in the processing of the subject project and the characteristics of one or a plurality of personnel allocated to the project. Hereinafter, the project may be referred to as a “subject project”, personnel allocated to the subject project may be referred to as a “subject personnel”, and a matter to be supplemented may be referred to as a “subject matter”. Here, the “requirement characteristic” means a characteristic required for personnel who processes the subject project. Here, estimating the subject matter based on the requirement characteristics and the characteristics of the personnel means directly or indirectly using the requirement characteristics and the characteristics of the personnel in estimating the subject matter. For example, estimating the subject matter using the analysis result obtained by analyzing the characteristics of the personnel is also included in the category of estimating the subject matter based on the requirement characteristics and the characteristics of the personnel. Here, the “characteristic” of personnel means at least one of characteristics and properties of the personnel, and can be rephrased as, for example, an “attribute” or the like.

The subject project may be a matter that can be processed by one or a plurality of personnel. For example, the subject project may be a work or activity planned for a specific purpose, a problem that needs discussion or solution, or the like.

The “subject matter” may be any matter that may improve the result of processing of the subject project in a case where the matter is supplemented. For example, the subject matter may be a characteristic, a skill, or the like that is necessary for processing the subject project but is not possessed by the subject personnel. For example, the subject matter may be a time that can be taken for processing of the subject project, a budget for processing of the subject project, or the like. As a method of estimating the subject matter, any method according to the matter to be estimated, information available for estimation, or the like may be applied. A specific example of the estimation method is described in the second illustrative example embodiment.

The allocation determination unit 102 determines a resource to be allocated to the subject project in addition to the personnel based on the estimation result by the analysis unit 101. Here, the “resource” may be any resource that can be used in a case where personnel processes a subject project and can supplement the above-described subject matter. For example, the resource may be software (for example, in addition to those that operate autonomously like a software agent, those that do not operate autonomously but function on software like a machine-learned model and the like are included) or hardware (for example, apparatuses, systems, databases, facilities, and the like) that can be used to process the subject project. In general, since the number of personnel that can be allocated is often limited, the resource allocated by the allocation determination unit 102 is a non-human resource. In other words, the personnel is not subject to allocation by the allocation determination unit 102. As a resource determination method, any method according to what resource is determined, an estimation result used for determining the resource, and the like may be applied. A specific example of a resource determining method is described in the second illustrative example embodiment.

Determining the resource based on the estimation result means directly or indirectly using the estimation result in determining the resource. For example, in a case where a resource is determined using information obtained by further analyzing the estimation result, it can be said that the resource is determined “based on the estimation result”.

As described above, the information processing apparatus 1 according to the present illustrative example embodiment employs a configuration including the analysis unit 101 that estimates a subject matter that is a matter to be supplemented for in processing of a subject project by a subject personnel based on a requirement characteristic required in processing of the subject project and a characteristic of one or a plurality of subject personnel allocated to the subject project, and the allocation determination unit 102 that determines a resource to be allocated to the subject project in addition to the subject personnel based on a result of estimation by the analysis unit 101.

According to the above configuration, the subject matter to be supplemented in the processing of the subject project is estimated, and the resource to be allocated to the subject project is determined based on the result of the estimation. Therefore, by using the determined resource, it is possible to appropriately process the subject project with a limited number of subject personnel. As described above, according to the information processing apparatus 1, even if the number of subject personnel that can be allocated to a subject project is limited, it is possible to provide assistance so that the subject project can be appropriately processed. According to the information processing apparatus 1, it is also possible to optimize personnel and resources to be allocated to a project.

### Project Processing Support Program

The functions of the information processing apparatus 1 described above can also be achieved by a program. A project processing support program according to the present illustrative example embodiment causes a computer to function as an analysis means for estimating a matter to be supplemented for in processing of a subject project by a subject personnel based on requirement characteristics required in processing of the subject project and characteristics of one or a plurality of subject personnel allocated to the subject project, and an allocation determination means for determining a resource to be allocated to the subject project in addition to the subject personnel based on a result of estimation by the analysis means. According to the project processing support program, even if the number of subject personnel that can be allocated to the subject project is limited, it is possible to provide support so that the subject project can be appropriately processed.

### Flow of Project Processing Support Method

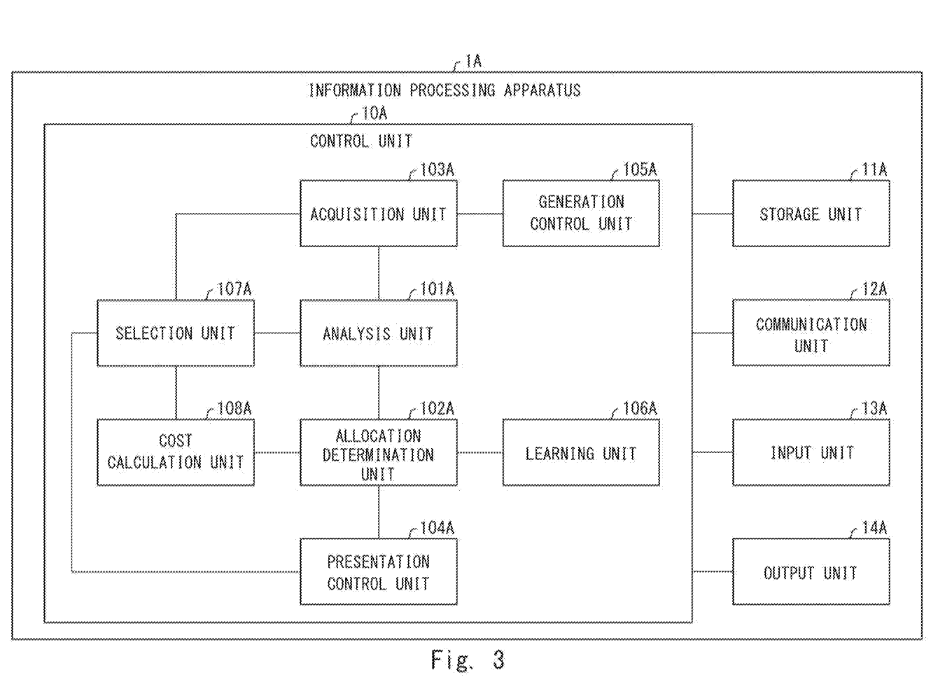

A flow of a project processing support method according to the present illustrative example embodiment will be described with reference to FIG. 2. FIG. 2 is a flowchart illustrating a flow of the project processing support method. An executing entity of each step in the project processing support method may be a processor included in the information processing apparatus 1, may be a processor included in another apparatus, or an executing entity of each step may be a processor provided in each of different apparatuses.

In S1 (analysis processing), at least one processor estimates matters to be supplemented for in the processing of the subject project by the subject personnel based on the requirement characteristics required in the processing of the subject project and the characteristics of one or a plurality of subject personnel allocated to the subject project.

In S2 (allocation determination processing), at least one processor determines a resource to be allocated to the subject project in addition to the subject personnel based on the estimation result in S1.

As described above, in the project processing support method according to the present illustrative example embodiment, a configuration is adopted in which at least one processor executes analysis processing of estimating a matter to be supplemented in processing of a subject project by a subject personnel based on requirement characteristics required in processing of the subject project and characteristics of one or a plurality of subject personnel allocated to the subject project, and allocation determination processing of determining a resource to be allocated to the subject project in addition to the subject personnel based on a result of the estimation in the analysis processing. According to the project processing support method, even if the number of subject personnel that can be allocated to the subject project is limited, it is possible to provide support so that the subject project can be appropriately processed.

### Second Illustrative Example Embodiment

A second illustrative example embodiment, which is an example of the example embodiments of the present disclosure, will be described in detail with reference to the drawings. Components having the same functions as the components described in the illustrative example embodiment described above are denoted by the same reference numerals, and descriptions thereof will be omitted as appropriate. An application range of each technique adopted in the present illustrative example embodiment is not limited to the present illustrative example embodiment. That is, each technique adopted in the present illustrative example embodiment can also be adopted in another illustrative example embodiment included in the present disclosure within a range in which no particular technical problem occurs. Each technique illustrated in each of the drawings referred to for describing the present illustrative example embodiment can be adopted in the other illustrative example embodiments included in the present disclosure within a range in which no particular technical problem occurs.

### Configuration of Information Processing Apparatus 1A

A configuration of an information processing apparatus 1A according to the present illustrative example embodiment will be described with reference to FIG. 3. FIG. 3 is a block diagram illustrating a configuration of the information processing apparatus 1A. The information processing apparatus 1A is an apparatus having a function of supporting processing of a project by one or a plurality of personnel. The information processing apparatus 1A may be a local apparatus used by individual users, or may be a server that provides project processing support services to a plurality of users.

As illustrated, the information processing apparatus 1A includes a control unit 10A for integrally controlling each unit of the information processing apparatus 1A, and a storage unit 11A for storing various types of data to be used by the information processing apparatus 1A. The information processing apparatus 1A includes a communication unit 12A for the information processing apparatus 1A to communicate with another apparatus, an input unit 13A for receiving an input to the information processing apparatus 1A, and an output unit 14A for the information processing apparatus 1A to output data.

Then, the control unit 10A includes an analysis unit 101A, an allocation determination unit 102A, an acquisition unit 103A, a presentation control unit 104A, a generation control unit 105A, a learning unit 106A, a selection unit 107A, and a cost calculation unit 108A. The processing units from the generation control unit 105A to the cost calculation unit 108A will be described later in the items of “Resource to be allocated” and “allocation of personnel”.

The acquisition unit 103A acquires various types of information necessary for supporting processing of the subject project. For example, the acquisition unit 103A acquires project information indicating the content of the subject project and personnel information regarding the subject personnel allocated to the subject project. Details of the project information and the personnel information will be described later. Any method is applied to acquire these pieces of information. For example, the acquisition unit 103A may acquire information from another apparatus by communication via the communication unit 12A, or may acquire information input to the information processing apparatus 1 via the input unit 13A.

Similarly to the analysis unit 101 of the first illustrative example embodiment, the analysis unit 101A estimates a subject matter that is a matter to be supplemented for in the processing of the subject project by the personnel based on the requirement characteristics required in the processing of the subject project and the characteristics of one or a plurality of subject personnel allocated to the subject project. Although details will be described later, the analysis unit 101A performs the above estimation using the project information and the personnel information acquired by the acquisition unit 103A.

Similarly to the allocation determination unit 102 of the first illustrative example embodiment, the allocation determination unit 102A determines a resource to be allocated to the subject project in addition to the subject personnel based on a result of estimation by the analysis unit 101A. Similarly to the first illustrative example embodiment, the resource allocated by the allocation determination unit 102A may be any resource as long as the resource is available in a case where the subject personnel processes the subject project and is a non-human resource that can supplement the subject matter estimated by the analysis unit 101A.

The presentation control unit 104A presents the result of the allocation by the allocation determination unit 102A to the user of the information processing apparatus 1A. For example, the presentation control unit 104A may present the resource to the user by causing the terminal apparatus used by the user to output information indicating the resource determined to be allocated by the allocation determination unit 102A. For example, the presentation control unit 104A may present the resource to the user by causing the output unit 14A to output the information. Any presentation mode is applied. For example, the presentation control unit 104A may cause the display apparatus to display the allocation result, may cause the voice output apparatus to output the allocation result by voice, or may cause the printing apparatus to print the allocation result.

### Method of Estimating Subject Matter

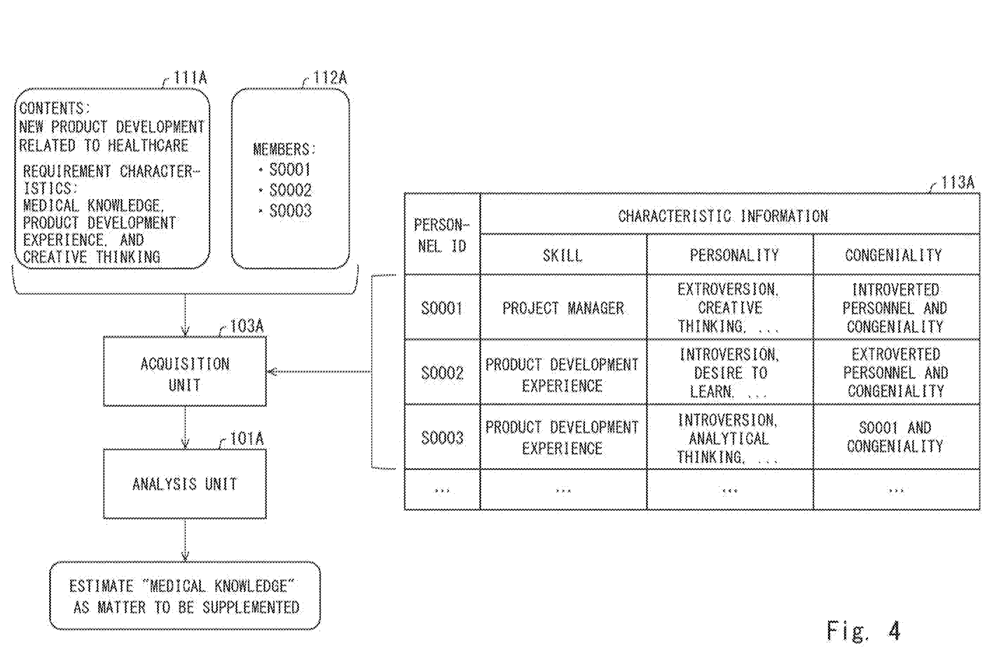

As described above, the analysis unit 101A estimates the subject matter using the project information and the personnel information acquired by the acquisition unit 103A. Hereinafter, an estimation example of the subject matter by the analysis unit 101A will be described with reference to FIG. 4. FIG. 4 is a diagram illustrating an estimation example of the subject matter.

In the example of FIG. 4, the acquisition unit 103A acquires project information 111A indicating the contents and the like of the subject project and member information 112A indicating subject personnel allocated to the subject project. These pieces of information may be input by, for example, a user of the information processing apparatus 1A (typically, an administrator who determines personnel in charge of a subject project). Although details will be described later, the information processing apparatus 1A can also determine the subject personnel regardless of the user's input.

The project information 111A illustrated in FIG. 4 is information indicating the content of the subject project and the requirement characteristics of the subject project. As described in the first illustrative example embodiment, the “requirement characteristic” means a characteristic required for personnel who handles a subject project. For example, the project information 111A indicates that the content of the subject project is “new product development related to healthcare”, and personnel who processes the project is required to have “medical knowledge”, “product development experience”, and “creative thinking”. In this manner, the information processing apparatus 1A can also be used for healthcare fields. The “requirement characteristic” can also be rephrased as a condition of personnel allocated to the subject project.

The acquisition unit 103A may acquire personnel information regarding the subject personnel after the subject personnel is determined. In the example of FIG. 4, the acquisition unit 103A acquires personnel information of three personnel (specifically, each personnel whose personnel ID is “S0001” to “S0003”) indicated in the member information 112A from a personnel information database 113A. The personnel information database 113A may be stored in the storage unit 11A or a storage device (for example, a personnel management server or the like of a company to which each personnel belongs) outside the information processing apparatus 1A. Instead of inputting the member information 112A, the personnel information of each subject personnel may be input. In this case, the acquisition unit 103A only needs to acquire the input personnel information, and does not need to extract the personnel information from the personnel information database 113A.

The personnel information may include at least information necessary for the analysis unit 101A to estimate the subject matter. In other words, the acquisition unit 103A may acquire information, as the personnel information, regarding the subject personnel used by the analysis unit 101A to estimate the subject matter.

Then, the analysis unit 101A estimates the subject matter based on the requirement characteristics required in the processing of the subject project and the characteristics of the subject personnel. As a result, it is possible to obtain an effect that a portion that cannot be covered by the characteristics of the subject personnel in the processing of the subject project can be supplemented by the resource allocation.

In a case where the subject matter is estimated based on the requirement characteristics of the subject project and the characteristics of the subject personnel, the acquisition unit 103A may acquire the project information 111A indicating the requirement characteristics and acquire the characteristic information indicated in the personnel information database 113A as the personnel information. The characteristic information in the personnel information database 113A in FIG. 4 indicates the skill, personality, and congeniality to other personnel. As described above, by using the characteristic information about the plurality of attributes, it is also possible to estimate the subject matter for each attribute. For example, the analysis unit 101A can estimate the subject matter to be supplemented for the skill by using the characteristic information indicating the skill of the subject personnel, and can estimate the subject matter to be supplemented for the personality by using the characteristic information indicating the personality of the subject personnel. The same applies to congeniality. Such characteristics may be derived from personnel evaluation of each personnel, a result of past project processing, or the like, or may be derived by Clifton strengths, a Myers-Briggs Type Indicator (MBTI), or the like. The analysis unit 101A may estimate the subject matter to be supplemented in the processing of the subject project using the characteristic information and the requirement characteristics of all the attributes without classifying the characteristic information by the attributes.

In the example of FIG. 4, among the three requirement characteristics of “medical knowledge”, “product development experience”, and “creative thinking”, “product development experience” is satisfied by a subject personnel with a personnel ID of “S0002” and a subject personnel with a personnel ID of “S0003”. The “creative thinking” is satisfied by the subject personnel whose personnel ID is “S0001”. On the other hand, no subject personnel has the “medical knowledge”. In this case, the analysis unit 101A can estimate the “medical knowledge” as a subject matter to be supplemented for in the processing of the subject project.

### Resource to be allocated

As described above, the resource allocated to the subject project by the allocation determination unit 102A may be any non-human resource that can supplement the subject matter estimated by the analysis unit 101A. For example, the allocation determination unit 102A may determine, as the resource to be allocated to the subject project, a software agent that behaves so as to have a characteristic that the subject personnel does not have among the requirement characteristics. As a result, in addition to the effects obtained by the information processing apparatus 1, it is possible to obtain an effect that it is possible to supplement the characteristics that the subject personnel does not have among the requirement characteristics by the software agent.

Here, the “software agent” means one programmed to execute a predetermined task and having a function of autonomously operating. For example, it is assumed that a characteristic that the subject personnel does not have among the requirement characteristics of a certain subject project is the ability of English conversation. In this case, the allocation determination unit 102A may allocate a software agent programmed to be able to execute a task of English translation to the subject project. The allocation determination unit 102A may determine an apparatus (for example, a robot) or the like for executing a task as a resource to be allocated to the subject project.

For example, the allocation determination unit 102A may determine an artificial intelligence (AI) agent, which is an agent using AI, as the resource to be allocated to the subject project. As a result, it is possible to expect an achievement of processing closer to the case of allocating personnel (or more than allocating personnel). The AI agent is also included in the category of the software agent.

For example, the allocation determination unit 102A may determine a language model subjected to machine learning so as to supplement the subject matter as the resource to be allocated to the subject project. As a result, in addition to the effects obtained by the information processing apparatus 1, it is possible to obtain an effect of enabling appropriate complementation similar to the case of supplementing the subject matter with an additional personnel.

For example, the allocation determination unit 102A may receive an input in a natural language of the subject personnel and determine a language model machine-learned so as to output an answer to the input, in other words, a language model machine-learned of a natural language, as the resource to be allocated to the subject project. Machine learning of a natural language more specifically means learning an arrangement of constituent elements (words etc.) in a sentence of a natural language and an arrangement of sentences in a writing. Examples of the language model trained on natural language include bidirectional encoder representations from transformers (BERT), robustly optimized BERT approach (RoBERTa), efficiently learning an encoder that classifies token replacements accurately (ELECTRA), and the like.

For example, a wide variety of language models and agents may be prepared in advance so that various projects can be supported. In this case, the allocation determination unit 102A may select a language model and an agent relevant to the subject matter from among language models and agents prepared in advance, and determine the selected language model and agent as the resource to be allocated to the subject project.

Here, as illustrated in FIG. 3, the information processing apparatus 1A includes a learning unit 106A. The learning unit 106A relearns the language model according to the subject matter. As a result, in addition to the effect obtained by the information processing apparatus 1, the information processing apparatus 1A can obtain an effect of more appropriately executing the processing of the subject project by the language model suitable for the subject matter. Relearning can also be referred to as fine tuning or the like.

In a case where the learning unit 106A is caused to perform relearning, the allocation determination unit 102A may determine a general-purpose language model as the resource to be allocated to the subject project. Then, the learning unit 106A may relearn the general-purpose language model allocated to the subject project according to the subject matter. This makes it possible to use a model obtained by optimizing a general-purpose language model for a subject matter for processing of the subject project.

For example, it is assumed that the subject project is new product development related to healthcare. In this case, the learning unit 106A may perform relearning of a general-purpose language model using training data including a technical term or the like in the healthcare field. As a result, a language model that can output an appropriate answer to a prompt including a technical term in the healthcare field can be used for processing of the subject project. The learning unit 106A may perform relearning of the language model used by the AI agent in a case where the AI agent allocated to the subject project by the allocation determination unit 102A uses the language model.

As illustrated in FIG. 3, the information processing apparatus 1A includes a generation control unit 105A. The generation control unit 105A performs control related to generation of an answer by the language model. For example, in a case where the subject project is processed using the language model allocated to the subject project, the generation control unit 105A may adjust the prompt input to the language model according to the subject matter. As a result, in addition to the effect obtained by the information processing apparatus 1, it is possible to obtain an effect that it is possible to cause the language model to generate an answer suitable for the subject matter and more appropriately execute processing of the subject project without performing relearning of the language model. Therefore, in a case where the generation control unit 105A is caused to adjust the prompt, the learning unit 106A may be omitted. Conversely, in a case where the learning unit 106A is caused to perform relearning, the generation control unit 105A may be omitted. Here, the adjustment of the prompt means that some change is made to the prompt, and can also be referred to as modifying or redesigning of the prompt.

For example, it is assumed that, in a case where the subject project is new product development related to healthcare, the allocation determination unit 102A determines a general-purpose language model as a resource to be allocated to the subject project. In this case, the generation control unit 105A starts monitoring the language model after processing of the subject project using the language model is started. In a case where the personnel allocated to the subject project transmits a prompt to input into the language model after the monitoring is started, the generation control unit 105A acquires the transmitted prompt, adjusts the acquired prompt according to the subject matter, and inputs the prompt into the language model. For example, the generation control unit 105A may perform adjustment to add a sentence for generating an answer according to the subject project such as “Please answer as an expert in product development related to healthcare” to the prompt transmitted by the personnel. Then, the generation control unit 105A transmits the answer output from the language model to the personnel. This makes it possible to present an answer suitable for the subject matter to the personnel.

How to adjust the prompt may be determined in advance. For example, the generation control unit 105A may generate a sentence to be added to a prompt by embedding the name, content, and the like of the subject project indicated in the project information in a portion of “XXX” in a template such as “Please answer as an expert of XXX”. For example, the generation control unit 105A may input the project information to the language model and generate an additional sentence to the prompt according to the project information.

For example, the generation control unit 105A can also cause a language model to refer to predetermined data relevant to a subject matter, thereby generating an answer suitable for the subject matter in the language model. In other words, the generation control unit 105A may determine a database to be referred to by the language model according to the subject matter.

For example, in a case where the subject project is a project related to medical or healthcare, the generation control unit 105A may cause the language model to refer to a database in which a medical related term and a medical related glossary describing the medical related term are recorded to generate an answer. For example, the generation control unit 105A can cause the language model to refer to predetermined data according to the subject matter by applying a technology such as retrieval-augmented generation (RAG).

### Method of Determining Resource to be allocated

What kind of resource the allocation determination unit 102A allocates to what kind of subject matter may be determined in advance. For example, in a case where a skill that is not possessed by personnel allocated to the subject project among skills required for the subject project is estimated as a subject matter, the allocation determination unit 102A may allocate an agent having the skill to the subject project. The allocation determination unit 102A may allocate a language model for supplementing the skill to the subject project. The allocation determination unit 102A may allocate a general-purpose language model to the subject project and cause the learning unit 106A to relearn the language model, or may cause the generation control unit 105A to adjust a prompt or the like in a case where the language model is used.

For example, in a case where it is estimated that there is room for improvement in congeniality between personnel allocated to the subject project as the subject matter, the allocation determination unit 102A may allocate a predetermined resource that can contribute to improvement in congeniality between personnel or a predetermined resource that can complement poor congeniality between personnel to the subject project. For example, in a case where all the personnel allocated to the subject project are congenial to extroverted personnel, but there is no extroverted personnel among the personnel allocated to the subject project, the allocation determination unit 102A may allocate an agent behaving as an extroverted personnel to the subject project.

Congeniality between personnel can also be expressed by a vector. For example, by performing machine learning in advance on the relationship between the characteristics of each personnel to be combined and the congeniality between the combined personnel, it is possible to estimate the congeniality between the personnel from the characteristics of the personnel allocated to the subject project. In this case, the analysis unit 101A may output a vector indicating congeniality between personnel allocated to the subject project as a congeniality estimation result. Then, the allocation determination unit 102A may allocate, to the subject project, an agent that behaves to improve the estimated congeniality. For example, the allocation determination unit 102A may allocate, to the subject project, an agent having a characteristic that congeniality of the entire team in a case where the subject personnel is added to the team is improved as compared with that before the addition.

For example, in a case where it is estimated that a risk in processing the subject project due to the personality of the personnel allocated to the subject project is the subject matter, the allocation determination unit 102A may allocate a predetermined resource capable of eliminating or reducing the risk to the subject project. Examples of the risk in processing the subject project include that personnel having a specific character is allocated (or not allocated), and that there is a predetermined bias that causes a risk in processing the subject project in the allocated personnel.

For example, in a case where personnel having an aggressive character is allocated to the subject project, the allocation determination unit 102A may allocate, to the subject project, an agent that behaves to follow the personnel who has been the target of the aggressive behavior. For example, in a case where personnel capable of paying attention to details of processing has not been allocated to the personnel allocated to the subject project, the allocation determination unit 102A may allocate, to the subject project, an agent who follows the details of processing. For example, in a case where a careful personnel has not been allocated to the personnel allocated to the subject project, the allocation determination unit 102A may allocate, to the subject project, an agent for appropriately prompting reconfirmation while processing of the subject project is in progress, or an agent having a project management function.

In a case where a plurality of requirement characteristics are set in the subject project, the analysis unit 101A may estimate a degree to which each requirement characteristic is satisfied (or a degree to which each requirement characteristic is not satisfied) from the personnel information of the subject personnel. Then, the allocation determination unit 102A may allocate, to the subject project, an agent having a characteristic that all the degrees of satisfying each requirement characteristic are equal to or greater than the threshold (or all the degrees of not satisfying each requirement characteristic are less than the threshold).

### Allocation of Personnel

As illustrated in FIG. 3, the information processing apparatus 1A includes a selection unit 107A. The selection unit 107A selects personnel to be allocated to the subject project. As a result, the information processing apparatus 1A can determine the subject personnel regardless of the user's input. The information processing apparatus 1A includes a cost calculation unit 108A in addition to the selection unit 107A. The cost calculation unit 108A calculates a cost for allocating a resource to a subject project.

The selection unit 107A can select personnel to be allocated to the subject project from among a plurality of candidates based on the cost of allocating the resource to the subject project. As a result, in addition to the effect obtained by the information processing apparatus 1, it is possible to automatically perform appropriate personnel allocation in consideration of the cost for allocating a resource to a subject project.

Specifically, for the resource determined to be allocated to the subject project by the allocation determination unit 102A, the cost calculation unit 108A calculates a cost required for allocating the resource to the subject project. For example, a cost necessary for allocating the resource may be set in advance for each resource which can be allocated. In this case, the cost calculation unit 108A can calculate the cost according to the setting. If the cost for causing the learning unit 106A to relearn the language model, the cost for causing the generation control unit 105A to adjust the prompt, and the like are also set in advance, the cost calculation unit 108A can calculate the cost according to the setting. Although the cost is basically assumed to be a monetary cost here, in a case where it takes time to arrange a resource (for example, in a case where the language model is relearned by the learning unit 106A), the cost calculation unit 108A may be caused to calculate a temporal cost, or may be caused to calculate both a temporal cost and a monetary cost, or may be caused to calculate a total cost in consideration of both a temporal cost and a monetary cost.

The selection unit 107A may select personnel so that the cost calculated by the cost calculation unit 108A satisfies a predetermined condition. For example, in a case where an upper limit of the cost is set, the selection unit 107A may select the personnel so that the cost calculated by the cost calculation unit 108A is equal to or less than the upper limit.

For example, the selection unit 107A may select personnel to be allocated to a subject project from among a plurality of candidates and generate a plurality of patterns of teams.

The selection unit 107A may cause the analysis unit 101A and the allocation determination unit 102A to determine an agent to be allocated to each team. Then, the selection unit 107A may cause the cost calculation unit 108A to calculate, for each team, a cost for allocating an agent, and determine the personnel of the team with the lowest calculated cost as the personnel to be allocated to the subject project.

The selection unit 107A may select personnel by optimization calculation. In this case, an objective function (for example, a function representing a cost for allocating a resource to a subject project) to be optimized and various constraint conditions (for example, the number of personnel that can be allocated) related to the optimization are set in advance. Then, the selection unit 107A determines an optimal personnel allocation by using the objective function and the constraint conditions. In this optimization calculation, in addition to the resource allocation cost, the personnel allocation cost may also be considered. This makes it possible to create an optimal team in consideration of the costs of both personnel and resources allocated to the subject project.

### Flow of Processing: Allocation of Agent

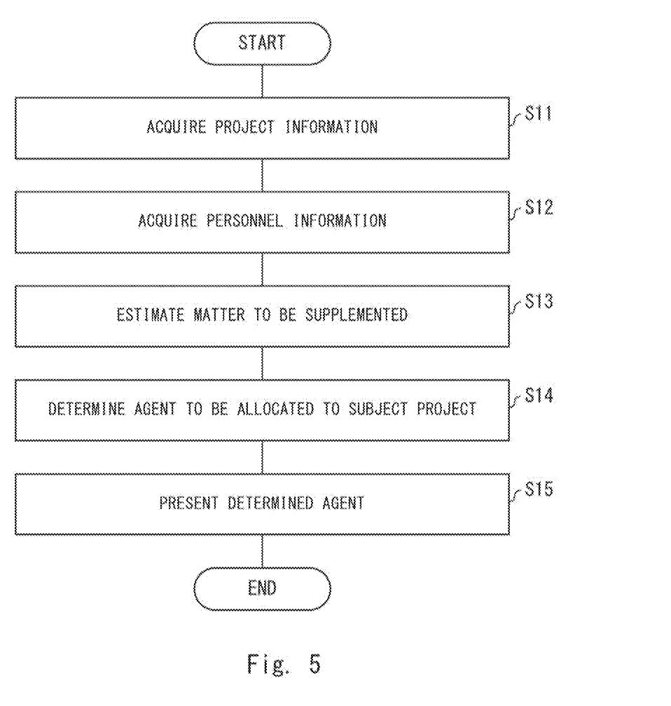

A flow of processing executed by the information processing apparatus 1A will be described with reference to FIG. 5. FIG. 5 is a flowchart illustrating an example of processing executed by the information processing apparatus 1A. The flowchart of FIG. 5 includes each processing of the project processing support method according to the present illustrative example embodiment. Although FIG. 5 illustrates an example in which an agent is allocated to a subject project, the flow of processing in a case where a resource other than the agent is allocated is substantially similar to that in FIG. 5.

In S11, the acquisition unit 103A acquires project information indicating the content of the subject project. For example, the acquisition unit 103A may acquire project information that is input via the communication unit 12A or the input unit 13A.

In S12, the acquisition unit 103A acquires personnel information regarding the subject personnel allocated to the subject project. For example, as in the example of FIG. 4, the acquisition unit 103A may acquire the member information 112A indicating the subject personnel allocated to the subject project via the communication unit 12A or the input unit 13A. Then, the acquisition unit 103A may acquire the personnel information of the personnel indicated in the member information 112A from the personnel information database 113A.

In S13 (analysis processing), the analysis unit 101A estimates the subject matter, which is a matter to be supplemented for in the processing of the subject project by the subject personnel, based on the requirement characteristics required in the processing of the subject project and the characteristics of the subject personnel indicated in the personnel information acquired in S12. Any acquisition source of the requirement characteristics of the subject project is applied. For example, in a case where the requirement characteristics required in the processing of the subject project are indicated in the project information acquired in S11, the analysis unit 101A may estimate the subject matter based on the requirement characteristics and the characteristics of the subject personnel indicated in the personnel information.

In S14 (allocation determination processing), the allocation determination unit 102A determines at least one agent as a resource to be allocated to the subject project in addition to the subject personnel based on the estimation result in S13. For example, the allocation determination unit 102A may determine to allocate, to the subject project, an agent that can supplement the subject matter among a plurality of agents that can be allocated to the subject project.

In S15, the presentation control unit 104A presents the agent determined in S14 to the user. Accordingly, the processing of FIG. 5 ends. In S14, a plurality of agents may be determined as candidates to be allocated to the subject project. In this case, in S15, the plurality of agents may be presented to allow the user to select a candidate to be allocated to the subject project.

In S14, in a case where there is no agent that can supplement the subject matter among the agents that can be allocated to the subject project, the allocation determination unit 102A may allocate an AI agent using a language model to the subject project. In this case, the allocation determination unit 102A may cause the learning unit 106A to perform relearning of the language model so that the AI agent has a function capable of supplementing the subject matter. The same applies to a case where the language model is allocated to the subject project instead of the AI agent.

### Flow of Processing: Adjustment of Prompt

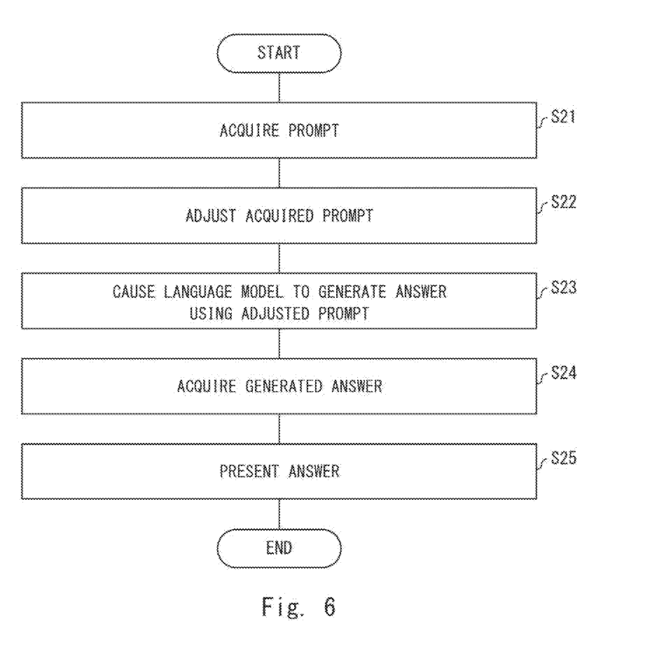

As described above, it is also possible to supplement the subject matter by causing the generation control unit 105A to adjust the prompt. FIG. 6 is a flowchart illustrating an example of processing executed by the generation control unit 105A. This processing is performed after the language model or the AI agent using the language model is allocated to the subject project and the generation control unit 105A starts monitoring the language model or the AI agent (more precisely, in a case where the subject personnel enters a prompt after the start of monitoring).

In S21, the generation control unit 105A acquires a prompt input by the subject personnel. For example, by setting the information processing apparatus 1A as an input destination of the prompt (that is, the instruction to the language model or the AI agent is performed via the information processing apparatus 1A), the generation control unit 105A can acquire the prompt input by the subject personnel.

In S22, the generation control unit 105A adjusts the prompt acquired in S21. The prompt adjustment is performed so that the prompt after the adjustment is appropriate for the subject matter. For example, the generation control unit 105A may adjust the prompt by incorporating the contents of at least one of the subject matter estimated by the analysis unit 101A, the personnel information used to estimate the subject matter, and the project information used to estimate the subject matter into the prompt. For example, the generation control unit 105A may perform adjustment to generate a sentence in which the subject matter is embedded in a template of “Please reply while being conscious of covering XXX.” and add the generated sentence to a prompt in a case where the subject matter is “a specific subject personnel's passivity”.

In S23, the generation control unit 105A inputs the prompt adjusted in S22 to the language model to generate an answer. The language model may be stored in the storage unit 11A or the like of the information processing apparatus 1A, or a language model stored in another apparatus (for example, a server) may be used.

In S24, the generation control unit 105A acquires an answer generated by the language model, and presents the acquired answer to the subject personnel in S25. Accordingly, the processing of FIG. 6 ends.

### Flow of Processing: Automatic Generation of Team including Personnel and Agent

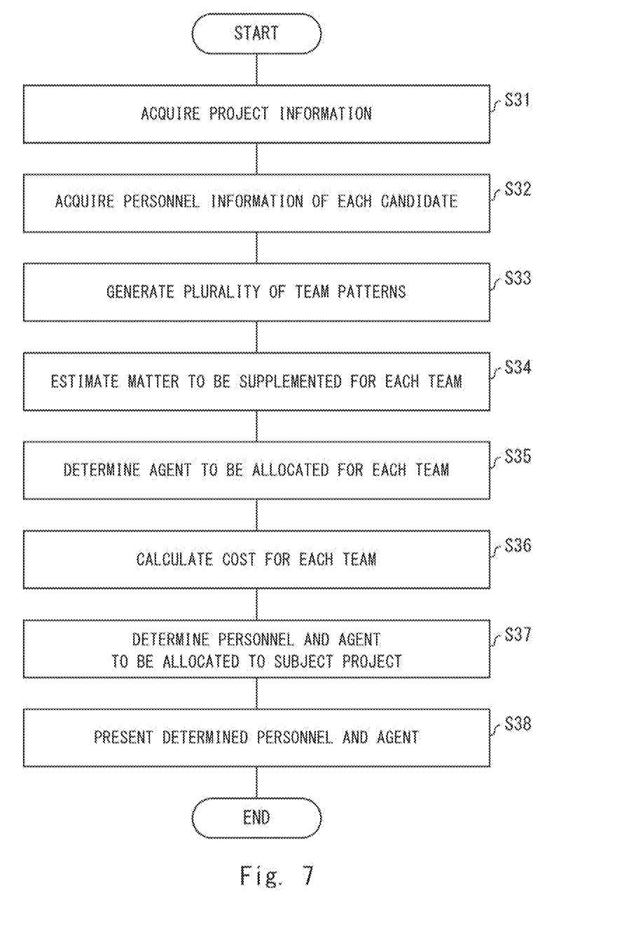

As described above, since the selection unit 107A can select personnel to be allocated to the subject project, it is also possible to automatically generate a team including the personnel and the agent by causing the allocation determination unit 102A to determine an agent to be allocated to the subject project. FIG. 7 is a flowchart illustrating an example of processing of automatically generating a team including personnel and an agent. The flowchart of FIG. 7 also includes each processing of the project processing support method according to the present illustrative example embodiment.

In S31, similarly to S11 in FIG. 5, the acquisition unit 103A acquires project information indicating the content of the subject project. Next, in S32, the acquisition unit 103A acquires personnel information regarding each of a plurality of candidates to be candidates to be allocated to the subject project.

In S33, the selection unit 107A combines the candidates to generate a plurality of patterns of teams for processing the subject project indicated in the project information acquired in S31. The selection unit 107A may generate a team by randomly combining the candidates, or may generate a team by combining the candidates based on at least one of the project information and the personnel information. In the latter case, a rule (for example, a candidate satisfying the requirement characteristic indicated in the project information may be preferentially selected and a candidate having good congeniality to a previously selected candidate may be preferentially selected, or the like) for how to combine candidates may be set in advance. This can increase the likelihood that an appropriate team will be created.

In S34 (analysis processing), the analysis unit 101A estimates the subject matter, which is a matter to be supplemented for in the processing of the subject project by the subject personnel, based on the requirement characteristics required in the processing of the subject project and the characteristics of the subject personnel included in the team generated in S33 (characteristics indicated in the personnel information acquired in S32). This processing is performed for each of the plurality of patterns of teams generated in S33.

In S35 (allocation determination processing), the allocation determination unit 102A determines at least one agent as a resource to be allocated to the team based on the estimation result in S34. This processing is performed for each of the plurality of patterns of teams generated in S33.

In S36, the cost calculation unit 108A calculates a cost for allocating the agent determined in S35 to the team. This processing is performed for each of the plurality of patterns of teams generated in S33. In S36, a total cost obtained by adding the cost for allocating the personnel of the team to the cost for allocating the agent may be calculated.

In S37, the selection unit 107A determines personnel and agents to be allocated to the subject project, that is, a team to process the subject project, based on the cost calculated in S36. Specifically, the selection unit 107A determines a team having the smallest value of the calculated cost among the teams for which the cost is calculated in S36 as a team that processes the subject project. The selection unit 107A may determine one or a plurality of teams whose calculated cost values are equal to or less than a predetermined threshold among the teams whose costs have been calculated in S36 as a team that processes the subject project. If there is no team whose cost is equal to or less than the predetermined threshold in S37, the process may return to S33 to generate a new team. In a case where the processing from S33 to S37 is repeatedly performed in this manner, only one pattern of a team may be generated in S33.

In S38, the presentation control unit 104A presents the user with the personnel and the agent determined in S37, in other words, a team including the personnel and the agent. Accordingly, the processing of FIG. 7 ends. A plurality of teams may be determined in S37. In this case, the plurality of teams may be presented in S38 to allow the user to select a team to be allocated to the subject project.

### Modified Examples

An executing entity of each processing described in the above-described illustrative example embodiments is optional, and is not limited to the above-described examples. For example, a system having functions similar to those of the information processing apparatuses 1 and 1A can be constructed by a plurality of apparatuses capable of communicating with each other. The executing entity of each processing illustrated in the flowcharts of FIGS. 5 to 7 may be one apparatus (may be rephrased as a processor) or a plurality of apparatuses (may be similarly rephrased as processors).

### Implementation Example by Software

Some or all of the functions of the information processing apparatuses 1 and 1A (hereinafter, also referred to as “each of the above apparatuses”) may be implemented by hardware such as an integrated circuit (IC chip) or may be implemented by software.

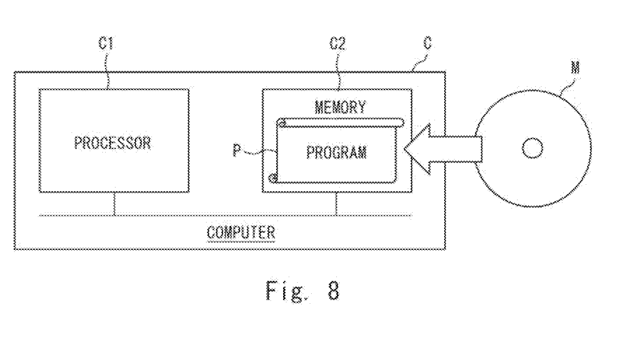

In the latter case, each of the above apparatuses is implemented by, for example, a computer that executes commands of a program, that is software for implementing each of the functions. An example of such a computer (hereinafter, referred to as a computer C) is illustrated in FIG. 8. FIG. 8 is a block diagram illustrating a hardware configuration of the computer C functioning as each of the above apparatuses.

The computer C includes at least one processor C1 and at least one memory C2. A program (project processing support program) P for operating the computer C as each of the above apparatuses is recorded in the memory C2. In the computer C, by the processor C1 reading the program P from the memory C2 and executing the program P, each of the functions of each of the above apparatuses is implemented.

As the processor C1, for example, a Central Processing Unit (CPU), a Graphic Processing Unit (GPU), a Digital Signal Processor (DSP), a Micro Processing Unit (MPU), a Floating point number Processing Unit (FPU), a Physics Processing Unit (PPU), a Tensor Processing Unit (TPU), a quantum processor, a microcontroller, a combination thereof or the like can be used. As the memory C2, for example, a flash memory, a Hard Disk Drive (HDD), a Solid State Drive (SSD), or a combination of these can be used.

The computer C may further include a Random Access Memory (RAM) for loading the program P at the time of execution and temporarily storing various types of data. The computer C may further include a communication interface for transmitting and receiving data to and from another apparatus. The computer C may further include an input/output interface for connecting input/output equipment such as a keyboard, a mouse, a display, and a printer.

The program P can be recorded on a non-transitory tangible recording medium M readable by the computer C. As such a recording medium M, for example, a tape, a disk, a card, a semiconductor memory, a programmable logic circuit, or the like can be used. The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

Each of the above functions of each of the above apparatuses may be implemented by a single processor provided in a single computer, may be implemented in cooperation by a plurality of processors provided in a single computer, or may be implemented in cooperation by a plurality of processors provided in a plurality of computers. The program for causing each of the above apparatuses to implement each of the above functions may be stored in a single memory provided in a single computer, may be stored in a distributed manner in a plurality of memories provided in a single computer, or may be stored in a distributed manner in a plurality of memories provided in each of a plurality of computers.

### Supplementary Information 1

The present disclosure includes the technologies described in the following Supplementary Notes. However, the present disclosure is not limited to the techniques described in the following Supplementary Notes, and various modifications may be made within the scope described in the claims.

### Supplementary Note A1

An information processing apparatus including an analysis means for estimating a matter to be supplemented in processing of a subject project by personnel based on requirement characteristics required in processing of the project and characteristics of one or a plurality of personnel allocated to the project, and an allocation determination means for determining a resource to be allocated to the project in addition to the personnel based on a result of the estimating.

### Supplementary Note A2

The information processing apparatus according to Supplementary Note A1, in which the allocation determination means is configured to execute determining, as a resource to be allocated to the project, a software agent that behaves to have a characteristic not possessed by the personnel among the requirement characteristics.

### Supplementary Note A3

The information processing apparatus according to Supplementary Note A1 or A2, in which the allocation determination means is configured to execute determining, as a resource to be allocated to the project, a language model machine-learned to supplement the matter.

### Supplementary Note A4

The information processing apparatus according to Supplementary Note A3, including a generation control means for adjusting a prompt input to the language model according to the matter.

### Supplementary Note A5

The information processing apparatus according to Supplementary Note A3 or A4, including a learning means for relearning the language model according to the matter.

### Supplementary Note A6

The information processing apparatus according to any one of Supplementary Notes A3 to A5, including a generation control means for determining a database referred to by the language model according to the matter.

### Supplementary Note A7

The information processing apparatus according to any one of Supplementary Notes A1 to A6, including a selection means for selecting personnel to be allocated to the project from among a plurality of candidates based on a cost for allocating the resource to the project.

### Supplementary Note B1

A project processing support method for causing at least one processor to execute analysis processing of estimating a matter to be supplemented in processing of a subject project by personnel based on requirement characteristics required in processing of the project and characteristics of one or a plurality of personnel allocated to the project, and allocation determination processing of determining a resource to be allocated to the project in addition to the personnel based on a result of the estimating.

### Supplementary Note B2

The project processing support method according to Supplementary Note B1, in which in the allocation determination processing the at least one processor determines, as a resource to be allocated to the project, a software agent that behaves to have a characteristic not possessed by the personnel among the requirement characteristics.

### Supplementary Note B3

The project processing support method according to Supplementary Note B1 or B2, in which in the allocation determination processing the at least one processor determines, as a resource to be allocated to the project, a language model machine-learned to supplement the matter.

### Supplementary Note B4

The project processing support method according to Supplementary Note B3, including generation control processing of adjusting, by the at least one processor, a prompt input to the language model according to the matter.

### Supplementary Note B5

The project processing support method according to Supplementary Notes B3 or B4, including learning processing of relearning, by the at least one processor, the language model according to the matter.

### Supplementary Note B6

The project processing support method according to any one of Supplementary Notes B3 to B5, including generation control processing of determining, by the at least one processor, a database to be referred to by the language model according to the matter.

### Supplementary Note B7

The project processing support method according to any one of Supplementary Notes B1 to B6, including selection processing of selecting, by the at least one processor, personnel to be allocated to the project from among a plurality of candidates based on a cost for allocating the resource to the project.

### Supplementary Note C1

A project processing support program for causing a computer to function as an analysis means for estimating a matter to be supplemented in processing of a subject project by personnel based on requirement characteristics required in processing of the project and characteristics of one or a plurality of personnel allocated to the project, and an allocation determination means for determining a resource to be allocated to the project in addition to the personnel based on a result of the estimating.

### Supplementary Note C2

The project processing support program according to Supplementary Note C1, in which the allocation determination means is configured to execute determining, as a resource to be allocated to the project, a software agent that behaves to have a characteristic not possessed by the personnel among the requirement characteristics.

### Supplementary Note C3

The project processing support program according to Supplementary Note C1 or C2, in which the allocation determination means is configured to execute determining, as a resource to be allocated to the project, a language model machine-learned to supplement the matter.

### Supplementary Note C4

The project processing support program according to Supplementary Note C3, in which the computer is caused to function as a generation control means for adjusting a prompt input to the language model according to the matter.

### Supplementary Note C5

The project processing support program according to Supplementary Note C3 or C4, in which the computer is caused to function as a learning means for relearning the language model according to the matter.

### Supplementary Note C6

The project processing support program according to any one of Supplementary Notes C3 to C5, in which the computer is caused to function as a generation control means for determining a database referred to by the language model according to the matter.

### SUPPLEMENTARY NOTE C7

The project processing support program according to any one of Supplementary Notes C1 to C6, in which the computer is caused to function as a selection means for selecting personnel to be allocated to the project from among a plurality of candidates based on a cost for allocating the resource to the project.

### Supplementary Note D1

An information processing apparatus including at least one processor, in which the at least one processor is configured to execute analysis processing of estimating a matter to be supplemented in processing of a subject project by personnel based on requirement characteristics required in processing of the project and characteristics of one or a plurality of personnel allocated to the project, and an allocation determination processing of determining a resource to be allocated to the project in addition to the personnel based on a result of the estimating.

The information processing apparatus may further include a memory. The memory may store a program for causing the at least one processor to execute each of the processing.

### Supplementary Note D2

The information processing apparatus according to Supplementary Note D1, in which in the allocation determination processing the at least one processor determines, as a resource to be allocated to the project, a software agent that behaves to have a characteristic not possessed by the personnel among the requirement characteristics.

### Supplementary Note D3

The information processing apparatus according to Supplementary Note D1 or D2, in which in the allocation determination processing the at least one processor determines, as a resource to be allocated to the project, a language model machine-learned to supplement the matter.

### Supplementary Note D4

The information processing apparatus according to Supplementary Note D3, in which the at least one processor executes generation control processing of adjusting a prompt input to the language model according to the matter.

### Supplementary Note D5

The information processing apparatus according to Supplementary Notes D3 or D4, in which the at least one processor executes learning processing of relearning the language model according to the matter.

### Supplementary Note D6

The information processing apparatus according to any one of Supplementary Notes D3 to D5, in which the at least one processor executes generation control processing of determining a database to be referred to by the language model according to the matter.

### Supplementary Note D7

The information processing apparatus according to any one of Supplementary Notes D1 to D6, in which the at least one processor executes selection processing of selecting personnel to be allocated to the project from among a plurality of candidates based on a cost for allocating the resource to the project.

### Supplementary Note E

A non-transitory recording medium having recorded therein a project processing support program for causing a computer to function as an information processing apparatus, the program causing the computer to execute analysis processing of estimating a matter to be supplemented in processing of a subject project by personnel based on requirement characteristics required in processing of the project and characteristics of one or a plurality of personnel allocated to the project, and allocation determination processing of determining a resource to be allocated to the project in addition to the personnel based on a result of the estimating.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

What is claimed is:

1. An information processing apparatus comprising:
at least one memory storing instructions; and
at least one processor configured to execute the instructions to:
estimate a matter to be supplemented in processing of a subject project by personnel based on requirement characteristics required in processing of the project and characteristics of one or a plurality of personnel allocated to the project; and
determine a resource to be allocated to the project in addition to the personnel based on a result of the estimating.

2. The information processing apparatus according to claim 1, wherein the at least one processor is further configured to execute the instruction to determine, as a resource to be allocated to the project, a software agent that behaves to have a characteristic not possessed by the personnel among the requirement characteristics.

3. The information processing apparatus according to claim 1, wherein the at least one processor is further configured to execute the instruction to determine, as a resource to be allocated to the project, a language model machine-learned to supplement the matter.

4. The information processing apparatus according to claim 3, wherein the at least one processor is further configured to execute the instruction to adjust a prompt input to the language model according to the matter.

5. The information processing apparatus according to claim 3, wherein the at least one processor is further configured to execute the instruction to relearn the language model according to the matter.

6. The information processing apparatus according to claim 3, wherein the at least one processor is further configured to execute the instruction to determine a database to be referred to by the language model according to the matter.

7. The information processing apparatus according to claim 1, wherein the at least one processor is further configured to execute the instruction to select personnel to be allocated to the project from among a plurality of candidates based on a cost for allocating the resource to the project.

8. A project processing support method for causing at least one processor to execute:
analysis processing of estimating a matter to be supplemented in processing of a subject project by personnel based on requirement characteristics required in processing of the project and characteristics of one or a plurality of personnel allocated to the project; and
allocation determination processing of determining a resource to be allocated to the project in addition to the personnel based on a result of the estimating.

9. A non-transitory computer readable medium having stored therein a project processing support program for causing a computer to execute:
estimating a matter to be supplemented in processing of a subject project by personnel based on requirement characteristics required in processing of the project and characteristics of one or a plurality of personnel allocated to the project; and
determining a resource to be allocated to the project in addition to the personnel based on a result of the estimating.
